(19) United States
(12) Patent Application Publication
(10) Pub. No.: US 2026/0277430 A1
(43) Pub. Date: Sep. 17, 2026

(54) ELECTRONIC DEVICE FOR PROVIDING INTERACTION WITH WIDGETS AND ITS OPERATION METHOD

(71) Applicant: Samsung Electronics Co., Ltd., Suwon-si (KR)

(72) Inventors: Seunghyun SEO, Suwon-si (KR); Jaemyoung LEE, Suwon-si (KR); Hyungmin KIM, Suwon-si (KR); Myoungwoo NAM, Suwon-si (KR); Pilseung YANG, Suwon-si (KR)

(21) Appl. No.: 19/678,412

(22) Filed: May 15, 2026

Related U.S. Application Data
(63) Continuation of application No. PCT/KR2024/017606, filed on Nov. 8, 2024.

(30) Foreign Application Priority Data
Dec. 7, 2023 (KR) 10-2023-0176589
Jan. 19, 2024 (KR) 10-2024-0009014
Jan. 23, 2024 (KR) 10-2024-0010360

(51) Int. Cl. G06F 3/04883; G06F 3/0482; G06F 3/04845

(52) U.S. Cl. CPC G06F 3/04883; G06F 3/0482; G06F 3/04845

(57) ABSTRACT

An electronic device is provided. The electronic device includes memory, including one or more storage media, storing instructions, and one or more processors communicatively coupled to the memory, wherein the instructions, when executed by the one or more processors individually or collectively, cause the electronic device to detect a first touch input with respect to a widget icon displaying a target item on a home screen, display, in response to detecting the first touch input, a control screen providing control over a widget, detect a second touch input with respect to the control screen displaying an item list, the item list including the target item and one or more candidate items associated with the widget, control, based on the second touch input, at least one of the target item or the one or more candidate items of the item list.

### CROSS-REFERENCE TO RELATED APPLICATION(S)

This application is a continuation application, claiming priority under 35 U.S.C. § 365(c), of an International application No. PCT/KR2024/017606, filed on November 8, 2024, which is based on and claims the benefit of a Korean patent application number 10-2023-0176589, filed on December 7, 2023, in the Ministry of Intellectual Property (MOIP), of a Korean patent application number 10-2024-0009014, filed on January 19, 2024, in the Ministry of Intellectual Property (MOIP), and of a Korean patent application number 10-2024-0010360, filed on January 23, 2024, in the Ministry of Intellectual Property (MOIP), the disclosure of each of which is incorporated by reference herein in its entirety.

### BACKGROUND

### 1. Field

The disclosure relates to an electronic device for providing an interaction with widgets and its operation method.

### 2. Description of Related Art

A widget may provide a specific function of an associated application. For example, a weather application widget may provide current weather information. For example, a music application widget may provide a control screen for a currently playing song. Widgets may be typically arranged on a home screen of an electronic device to enable interaction with a user. By interacting with the user, a widget may enable the user to immediately view necessary information or easily perform a specific operation, thereby improving user experience.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for providing an interaction with widgets and its operation method.

Additional aspects will be set forth in part in the description which follows and, in part, will be apparent from the description, or may be learned by practice of the presented embodiments.

In accordance with an aspect of the disclosure, an electronic device is provided. The electronic device includes memory, including one or more storage media, storing instructions, and one or more processors communicatively coupled to the memory, wherein the instructions, when executed by the one or more processors individually or collectively, cause the electronic device to detect a first touch input with respect to a widget icon displaying a target item on a home screen, display, in response to detecting the first touch input, a control screen providing control over a widget, detect a second touch input with respect to the control screen displaying an item list, the item list including the target item and one or more candidate items associated with the widget, control, based on the second touch input, at least one of the target item or the one or more candidate items of the item list, wherein the target item and the one or more candidate items each provide at least a portion of functions of an application associated with the widget, and wherein the one or more candidate items are items that (i) replace the target item and (ii) are displayed on the home screen as the widget icon.

In accordance with another aspect of the disclosure, an electronic device is provided. The electronic device includes memory, including one or more storage media, storing instructions, and one or more processors communicatively coupled to the memory, wherein the instructions, when executed by the one or more processors individually or collectively, cause the electronic device to detect a first touch input with respect to a widget icon displaying a target item on a home screen, display, in response to detecting the first touch input, a control screen providing control over a widget through a visual effect that expands a size of the target item, detect a second touch input with respect to the control screen displaying an item list, the item list including the target item and one or more candidate items associated with the widget, and control, based on the second touch input, at least one of the target item or the one or more candidate items of the item list, and wherein the item list is arranged such that each of the one or more candidate items, below the target item at a top position, at least partially overlaps with a consecutive item.

In accordance with another aspect of the disclosure, a method of operating an electronic device is provided. The method includes detecting a first touch input with respect to a widget icon displaying a target item on a home screen, displaying, in response to the detecting of the first touch input, a control screen providing control over a widget, detecting a second touch input with respect to the control screen displaying an item list, the item list including the target item and one or more candidate items associated with the widget, and controlling, based on the second touch input, at least one of the target item or the one or more candidate items of the item list, wherein the target item and the one or more candidate items each provide at least a portion of functions of an application associated with the widget, and wherein the one or more candidate items are items that (i) replace the target item and (ii) are displayed on the home screen as the widget icon.

In accordance with another aspect of the disclosure, an operating method is provided. The operating method includes detecting a first touch input with respect to a widget icon displaying a target item on a home screen, displaying, in response to the detecting of the first touch input, a control screen providing control over a widget through a visual effect that expands a size of the target item, detecting a second touch input with respect to the control screen displaying an item list, the item list including the target item and one or more candidate items associated with the widget, and controlling, based on the second touch input, at least one of the target item or the one or more candidate items of the item list, and wherein the item list is arranged such that each of the one or more candidate items, below the target item at a top position, at least partially overlaps with a consecutive item.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include detecting a first touch input with respect to a widget icon displaying a target item on a home screen, displaying, in response to the detecting of the first touch input, a control screen providing control over a widget, detecting a second touch input with respect to the control screen displaying an item list, the item list including the target item and one or more candidate items associated with the widget, and controlling, based on the second touch input, at least one of the target item or the one or more candidate items of the item list, wherein the target item and the one or more candidate items each provide at least a portion of functions of an application associated with the widget, and wherein the one or more candidate items are items that (i) replace the target item and (ii) are displayed on the home screen as the widget icon.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment, according to an embodiment of the disclosure;

FIG. 2 is a diagram illustrating control over a widget through a control screen according to an embodiment of the disclosure;

FIG. 3 is a diagram illustrating a visual effect provided upon entry into a control screen according to an embodiment of the disclosure;

FIG. 4 is a diagram illustrating an arrangement of items according to an embodiment of the disclosure;

FIG. 5 is a diagram illustrating a display of an indicator according to an embodiment of the disclosure;

FIG. 6 is a diagram illustrating a method of displaying items according to an embodiment of the disclosure;

FIGS. 7 and 8 are diagrams illustrating control over a widget based on a second touch input according to various embodiments of the disclosure;

FIG. 9 is a diagram illustrating a separate interaction according to an embodiment of the disclosure; and

FIG. 10 is a diagram illustrating a method of operating an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions of may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

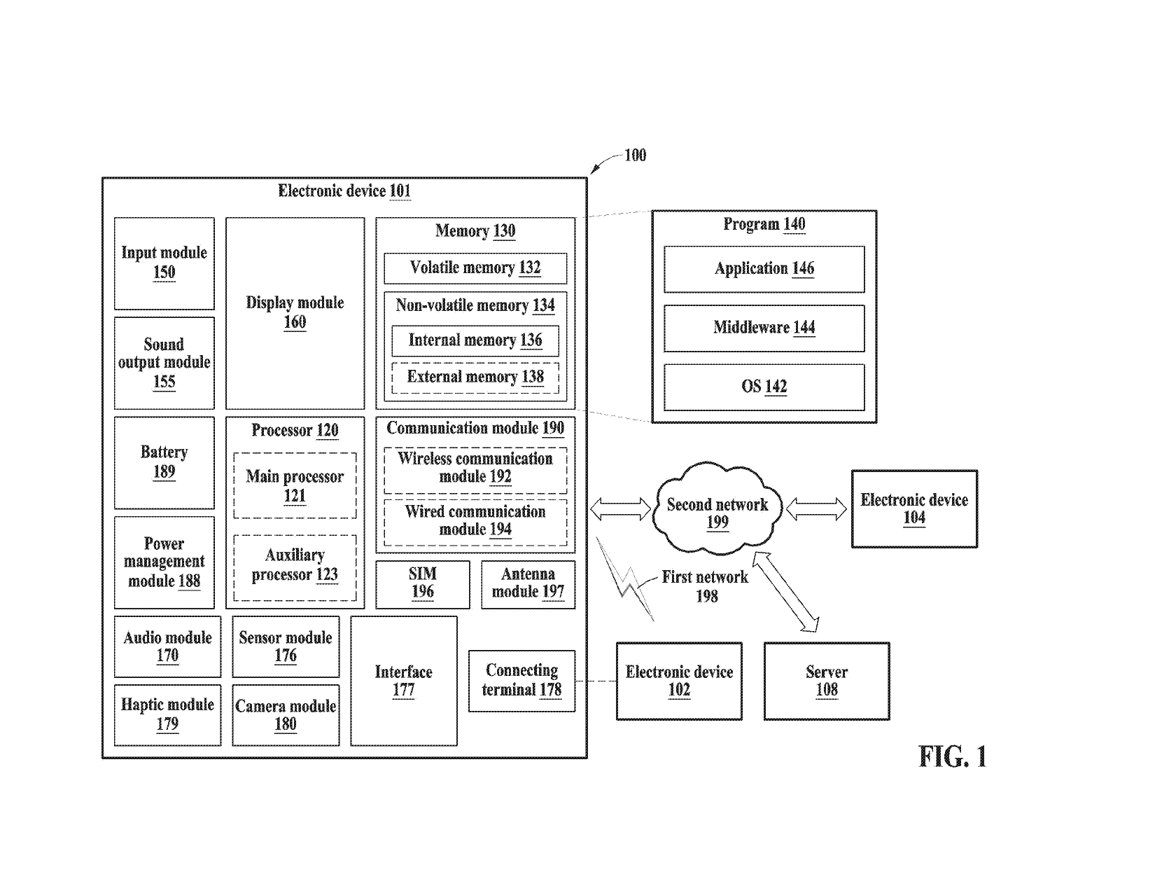

FIG. 1 is a block diagram illustrating an electronic device 101 in a network environment 100 according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be dedicated for a designated function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state, or together with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. The AI model may be generated by machine learning. Such learning may be performed by, for example, the electronic device 101 in which an AI model is executed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via an external electronic device (e.g., an electronic device 102) (e.g., a speaker or headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used by the electronic device 101 to couple with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a millimeter wave (mmWave) band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as part of the antenna module 197. According to various embodiments, the antenna module 197 may form a mmWave antenna module. According to an embodiment, the mmWave antenna module may include a PCB, an RFIC disposed on a first surface (e.g., the bottom surface) of the PCB or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of a same type as, or a different type from, the electronic device 101. According to an embodiment, all or some of operations to be executed by the electronic device 101 may be executed at one or more external electronic devices (e.g., the external devices 102 and 104, and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and may transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra-low-latency services using, e.g., distributed computing or MEC. In an embodiment, the external electronic device (e.g., the electronic device 104) may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment, the electronic device is not limited to those described above.

It should be understood that various embodiments of the disclosure and the terms used therein are not intended to limit the technological features set forth herein to particular embodiments and include various changes, equivalents, or replacements for a corresponding embodiment. As used herein, "A or B," "at least one of A and B," "at least one of A or B," "A, B or C," "at least one of A, B and C," and "at least one of A, B, or C," each of which may include any one of the items listed together in the corresponding one of the phrases, or all possible combinations thereof. Terms such as "1st" and "2nd," or "first" and "second" may be used to simply distinguish a corresponding component from other components, and do not limit the components in other aspects (e.g., importance or order). It is to be understood that if a component (e.g., a first component) is referred to, with or without the term "operatively" or "communicatively," as "coupled with," "coupled to," "connected with," or "connected to" another component (e.g., a second component), the component may be coupled with the other component directly (e.g., by wire), wirelessly, or via a third component.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to an embodiment, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

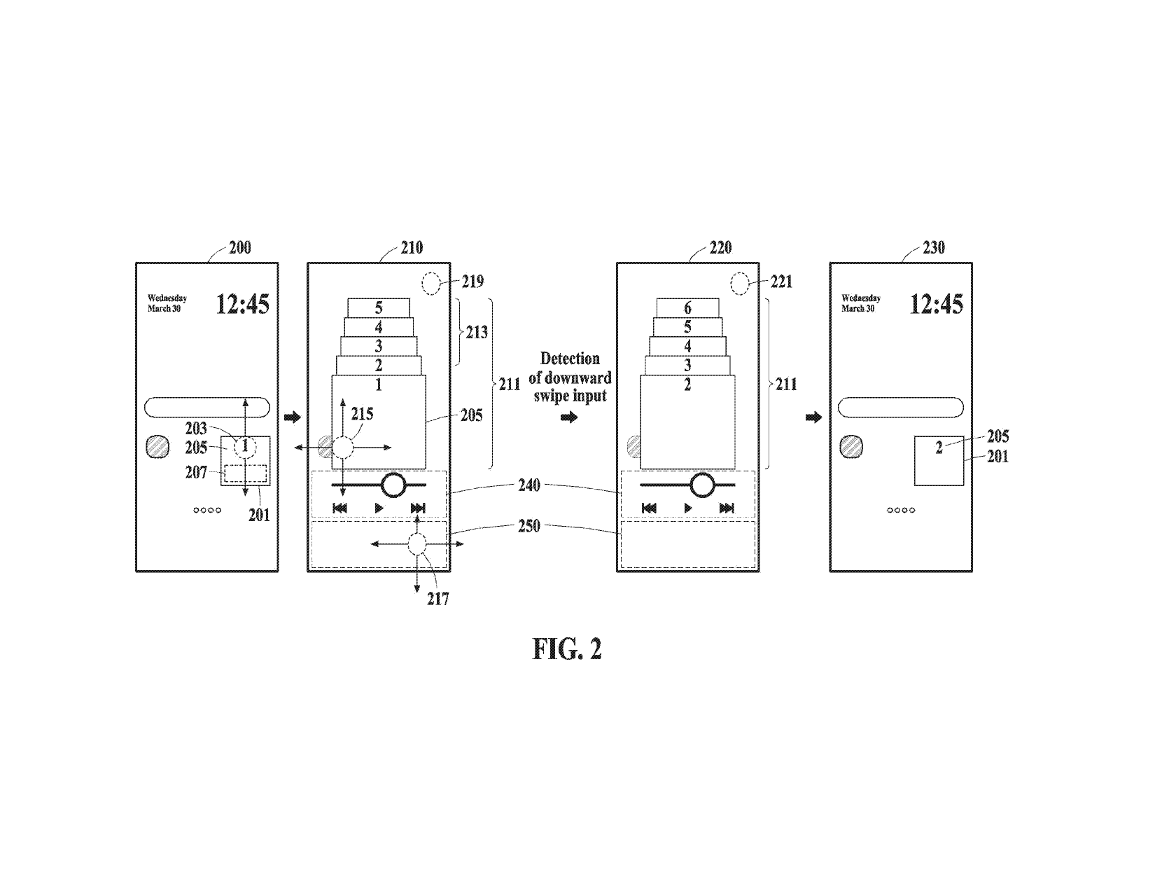

FIG. 2 is a diagram illustrating control of a widget through a control screen according to an embodiment of the disclosure.

Referring to FIG. 2, screens (e.g., home screens 200 to 230) displayed through a display module (e.g., the display module 160 of FIG. 1) of an electronic device (e.g., the electronic device 101 of FIG. 1) are illustrated. For ease of description, only the screens of the electronic device are illustrated, and the electronic device and the display module are omitted.

The electronic device may provide the home screen 200 on which one or more widget icons are arranged. The home screen 200 may be a page among a plurality of pages included in the home screen. A widget may be a user interface (UI) object providing at least a portion of functions of a specific application. For example, a weather application widget may provide current weather information. For example, a music application widget may provide a control screen for a currently playing song.

A user may interact with an application without accessing the application via a widget icon. The electronic device may provide a user experience associated with an application via a widget icon without displaying an execution screen of the application and may include, for example, various computing devices, such as a mobile phone, a smartphone, a tablet personal computer (PC), an e-book device, a laptop, a PC, a desktop, a workstation, or a server, various wearable devices, such as a smart watch, smart eyeglasses, or a head-mounted display (HMD), various home appliances such as a smart speaker, a smart television (TV), or a smart refrigerator, and other devices, such as a smart vehicle, a smart kiosk, an IoT device, a walking assist device (WAD), a drone, or a robot.

The electronic device may provide a widget icon 201 on the home screen 200. A target item 205 may be displayed on the widget icon 201. The target item 205 may be associated with a function of an application provided by a widget. For example, in a music widget, the target item 205 displayed on the widget icon 201 may be an album cover of a song. For example, in a weather widget, the target item 205 displayed on the widget icon 201 may be current weather information. For example, in a gallery widget, the target item 205 displayed on the widget icon 201 may be a most recently stored photo. For example, in a note widget, the target item 205 displayed on the widget icon 201 may be the most recently written note. Item 1 may be displayed as the target item 205 on the home screen 200.

On the home screen 200, the electronic device may detect a first touch input with respect to the widget icon 201. The electronic device may detect a touch 203 on the widget icon 201. The touch 203 may be a contact with an area included in the widget icon 201.

The electronic device may detect an upward swipe input or a downward swipe input with respect to the widget icon 201 after the touch 203. The electronic device may display a control screen 210 for controlling a widget when detecting an upward swipe input or a downward swipe input with respect to the widget icon 201 after the touch 203. An input that causes the electronic device to enter the control screen 210 from the home screen 200 may be referred to as a first touch input. In other words, the first touch input may include the touch 203 on the widget icon 201 and an upward swipe input or a downward swipe input with respect to the widget icon 201 after the touch 203. The electronic device may switch from the home screen 200 to the control screen 210 through a visual effect that expands the size of the target item 205 displayed on the widget icon 201.

The electronic device may display an item list 211 associated with a widget on the control screen 210. The target item 205 (i.e., item 1) may be arranged at the top of the item list 211. One or more candidate items 213 (i.e., items 2 through 5) may be arranged below the target item 205. The one or more candidate items 213 may replace the target item 205 and may be displayed on the home screen as the widget icon 201. In the item list 211, the target item 205 and the one or more candidate items 213 may be arranged in a stack view such that each may at least partially overlap with a consecutive item. In the disclosure, both the target item 205 and the one or more candidate items 213 may be referred to as items, and the items may be classified as the target item 205 or the one or more candidate items 213 based on whether the items are displayed on the widget icon 201 in the home screen (e.g., the home screen 200 or 220).

The limited size of the display module may prevent the electronic device from displaying all candidate items in the item list 211. For example, the number of predetermined items that may be displayed in the item list 211 may be five, while the number of candidate items may be eight. In this case, the electronic device may display only the target item 205 and four candidate items in the item list 211.

The target item 205 and the one or more candidate items 213 may provide at least a portion of functions of an application associated with a widget and may be items arranged according to various conditions. For example, in a music widget, the target item 205 may be a currently playing song, and the one or more candidate items 213 may be upcoming songs. For example, in a weather widget, the target item 205 may be the current weather, and the one or more candidate items 213 may be the weather for the next day. For example, in a gallery widget, the target item 205 may be the most recently stored photo, and the one or more candidate items 213 may be previously stored photos. For example, in a note widget, the target item 205 may be the most recently written note, and the one or more candidate items 213 may be previously written notes.

The electronic device may detect a second touch input with respect to the item list 211 while displaying the control screen 210. The electronic device may detect a touch 215 on the item list 211 while displaying the control screen 210. The touch 215 may be a contact with the target item 205 or one or more candidate items 213.

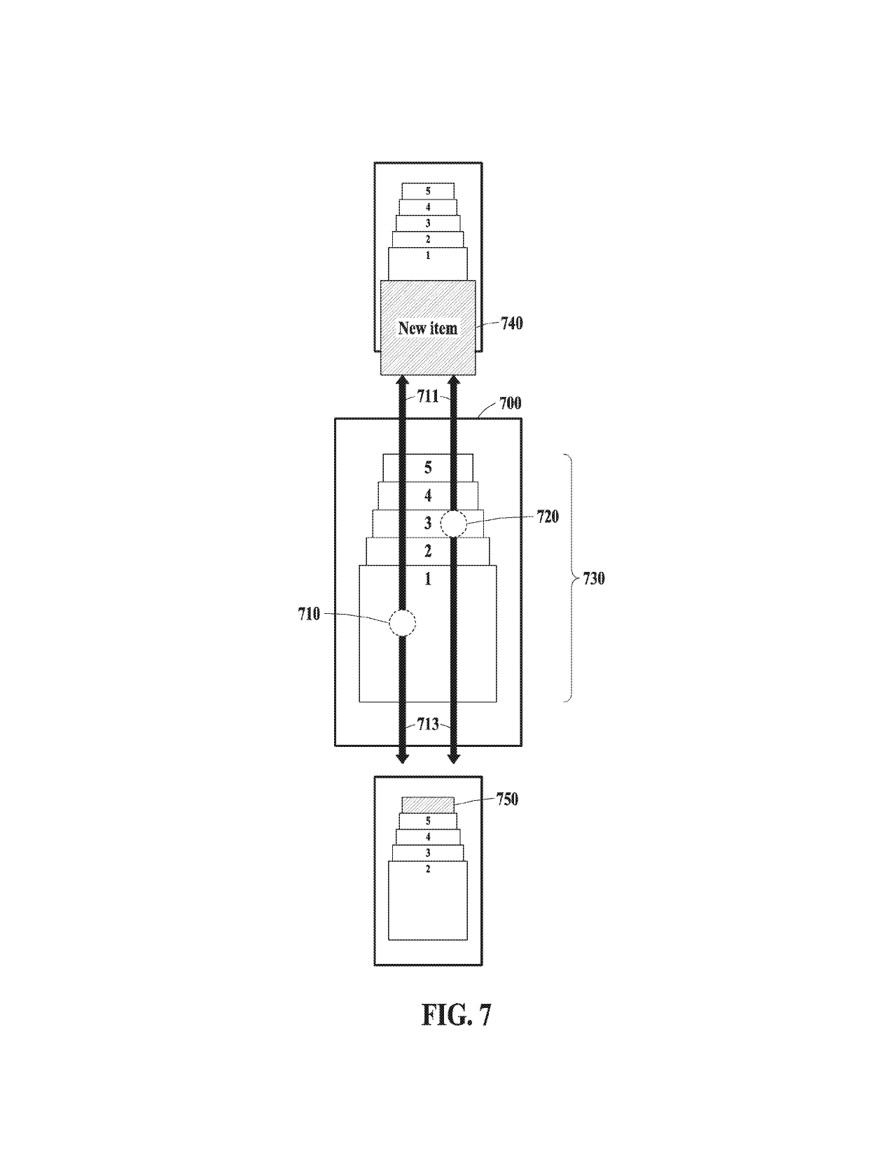

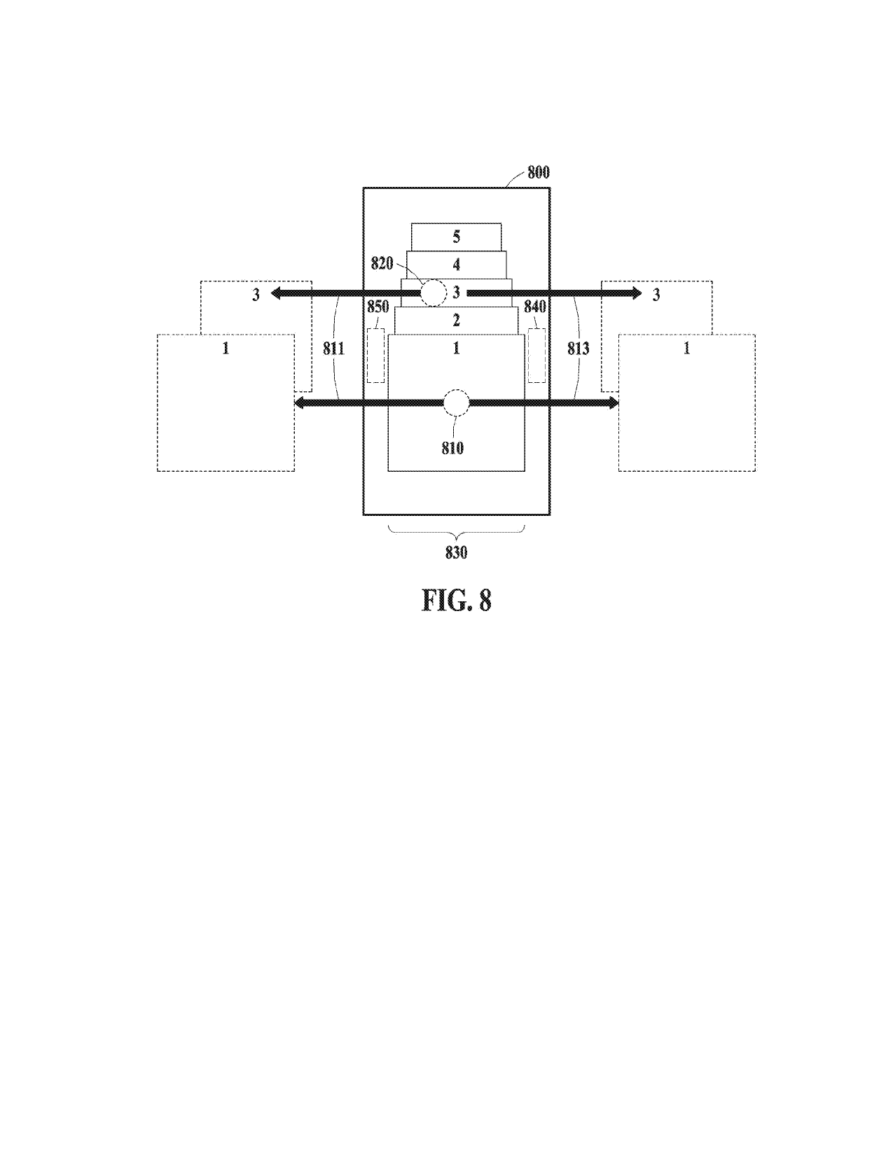

The electronic device may detect a swipe input in a first direction, a second direction, a third direction, or a fourth direction after the touch 215. The electronic device may control the item list 211 based on a swipe input in a specific direction detected after the touch 215. The input that controls the item list 211 may be referred to as a second touch input. The second touch input may include the touch 215 and a swipe input in a specific direction after the touch 215. Each of the first direction, the second direction, the third direction, and the fourth direction may be one of left, right, downward, and upward. For example, the first direction may be left, the second direction may be right, the third direction may be downward, and the fourth direction may be upward. However, this is just an example, and the disclosure is not limited thereto. A method of controlling the item list 211 based on a second touch input will be described with reference to FIGS. 7 and 8.

According to an embodiment, the widget icon 201 on the home screen 200 may include control objects 207 for controlling a widget. For example, when the widget icon 201 is an icon for a music widget, the control objects 207 may include a play/pause button, a rewind button, and a fast forward button. In response to switching from the home screen 200 to the control screen 210, the control objects 207 may move to a control area 240. In response to switching from the home screen 200 to the control screen 210, the control objects 207 may move to the control area 240 through a visual effect that separates the control objects 207 from the target item 205. In response to switching from the home screen 200 to the control screen 210, an arrangement between the control objects 207 and the target item 205 may be maintained. For example, when the control objects 207 are arranged at a bottom portion of the widget icon 201 on the home screen 200, the control objects 207 on the control screen 210 may be arranged at a bottom portion of the item list 211.

According to an embodiment, the control screen 210 may include a touch pad area 250. The electronic device may detect a touch 217 on the touch pad area 250. The electronic device may detect a swipe input in the first direction, the second direction, the third direction, or the fourth direction after the touch 217 on the touch pad area 250. The electronic device may control the item list 211 based on a swipe input in a specific direction detected after the touch 217. Control over the item list 211 based on a swipe input in a specific direction after the touch 217 is the same as control over the item list 211 based on a swipe input in a specific direction after the touch 215, and thus a repeated description thereof will be omitted. Control over the item list 211 through the touch pad area 250 may be limited to an item arranged at the top of the item list 211.

According to an embodiment, the electronic device may detect a specific touch gesture input with respect to the touch pad area 250. The electronic device may detect a specific touch gesture and perform an operation mapped to the specific touch gesture. For example, in response to detecting a double tap on the touch pad area 250, the electronic device may perform a predetermined operation mapped to the double tap.

According to an embodiment, the electronic device may detect a touch 219 on an area of the control screen 210 excluding the item list 211, the control area 240, and the touch pad area 250. The area of the control screen 210 excluding the item list 211, the control area 240, and the touch pad area 250 may be a blurred background. In response to detecting the touch 219, the electronic device may exit the control screen 210 and display the home screen 200.

When the electronic device detects a second touch input, the electronic device may control the item list 211 in response to the second touch input. In the disclosure, it is assumed that the electronic device detects a downward swipe input after the touch 215. When the electronic device detects a downward swipe input after the touch 215, the electronic device may arrange a candidate item (i.e., item 2) directly below the target item 205 at the top of the item list 211, together with a visual effect in which the target item 205 slides downward, is blurred, and disappears. In other words, item 2 may be determined as the target item 205.

Referring to the control screen 220, the item list 211 is illustrated with item 2 arranged at the top based on a downward swipe input after the touch 215 on the control screen 210. Accordingly, as item 2 is arranged at the top of the item list 211 on the control screen 210, item 6 may be newly displayed at the bottom of the item list 211.

The electronic device may detect a touch 221 on an area of the control screen 220 excluding the item list 211, the control area 240, and the touch pad area 250. The area of the control screen 220 excluding the item list 211, the control area 240, and the touch pad area 250 may be a blurred background.

In response to detecting the touch 221, the electronic device may exit the control screen 220 and display the home screen 230. The electronic device may provide the widget icon 201 on the home screen 230. When the electronic device exits the control screen 220, the electronic device may display, on the home screen 230, an item arranged at the top of the item list 211 as the target item 205 of the widget icon 201. In other words, in response to exiting the control screen 220, item 2, the item arranged at the top of the item list 211, may be displayed as the target item 205 of the widget icon 201.

The electronic device may provide control over an application without executing the application by providing a control screen in response to a first touch input.

Hereinafter, a visual effect provided upon entry to the control screen 210 will be described.

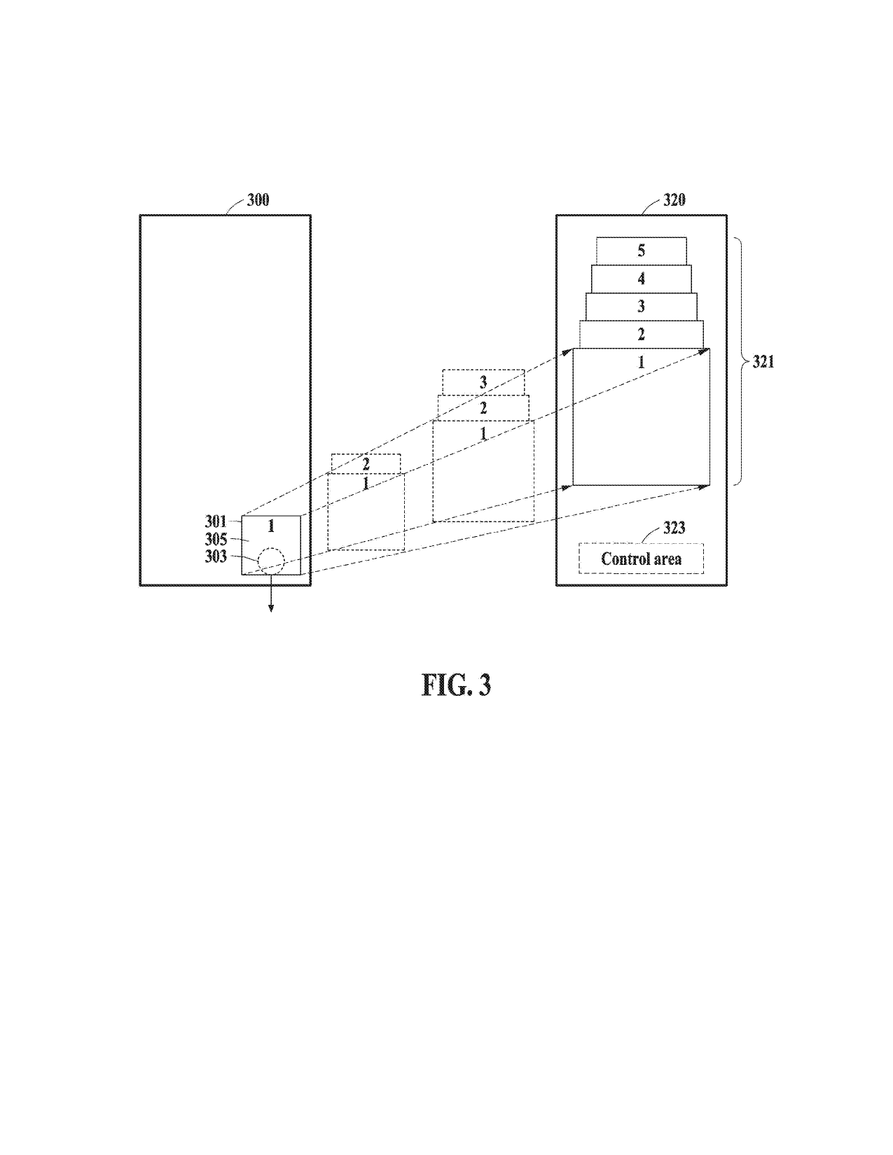

FIG. 3 is a diagram illustrating a visual effect provided upon entry into a control screen according to an embodiment of the disclosure.

Referring to FIG. 3, a home screen 300 (e.g., the home screen 200 of FIG. 2 or the home screen 230 of FIG. 2) displaying a widget icon 301 (e.g., the widget icon 201 of FIG. 2) is illustrated. The widget icon 301 may display a target item 305 (e.g., the target item 205 of FIG. 2). In FIG. 3, the target item 305 may be item 1.

An electronic device (e.g., the electronic device 101 of FIG. 1) may detect a first touch input with respect to the widget icon 301. The description of the first touch input has been provided above with reference to FIG. 2, and thus a repeated description thereof will be omitted.

In response to detecting the first touch input, the electronic device may provide a control screen 320 (e.g., the control screen 210 of FIG. 2 or the control screen 220 of FIG. 2) through a visual effect that expands the size of the target item 305 based on the first touch input. The electronic device may provide, together with a visual effect that expands the size of the target item 305, a visual effect that slides the one or more candidate items (e.g., items 2 through 5) (e.g., the one or more candidate items 213 of FIG. 2) upward or downward relative to the target item 305. The electronic device may provide a visual effect that slides the one or more candidate items upward in response to detecting a downward swipe input after a touch 303 (e.g., the touch 203 of FIG. 2). The electronic device may provide a visual effect that slides the one or more candidate items downward in response to detecting an upward swipe input after the touch 303.

Referring to FIG. 3, the electronic device may detect a downward swipe input after the touch 303 on the widget icon 301. Accordingly, the electronic device may provide, together with a visual effect that expands the size of the target item 305, a visual effect that slides the one or more candidate items upward relative to the target item 305.

When providing a visual effect that slides the one or more candidate items, the electronic device may display different numbers of candidate items depending on the degree of expansion of the target item 305. In other words, as the size of the target item 305 increases, a greater number of candidate items may slide and be displayed.

The control screen 320 displayed through the above-described visual effects may include an item list 321 (e.g., the item list 211 of FIG. 2) including the target item 305 and the one or more candidate items.

The electronic device may provide a visual effect based on information regarding the size of the widget icon 301 on the home screen 300, information regarding the position of the widget icon 301, information regarding a round value indicating a degree of roundness of a vertex of the widget icon 301, and information regarding a shadow effect of the widget icon 301. The electronic device may have size information for an expanded target item on the control screen 320, position information for the expanded target item, round value information indicating a degree of roundness of a vertex of the expanded target item, and information regarding a shadow effect of the expanded target item. The electronic device may have information regarding the widget icon 301 and information regarding the expanded target item and may provide a smooth and natural visual effect.

According to an embodiment, the widget icon 301 may further include control objects (e.g., the control objects 207 of FIG. 2). In response to detecting a first touch input, the electronic device may display control objects in a control area 323 (e.g., the control area 240 of FIG. 2) through a visual effect that expands the sizes of the control objects. The visual effect that expands the sizes of the control objects is the same as the visual effect that expands the size of the widget icon 301 described above, and thus a repeated description thereof will be omitted.

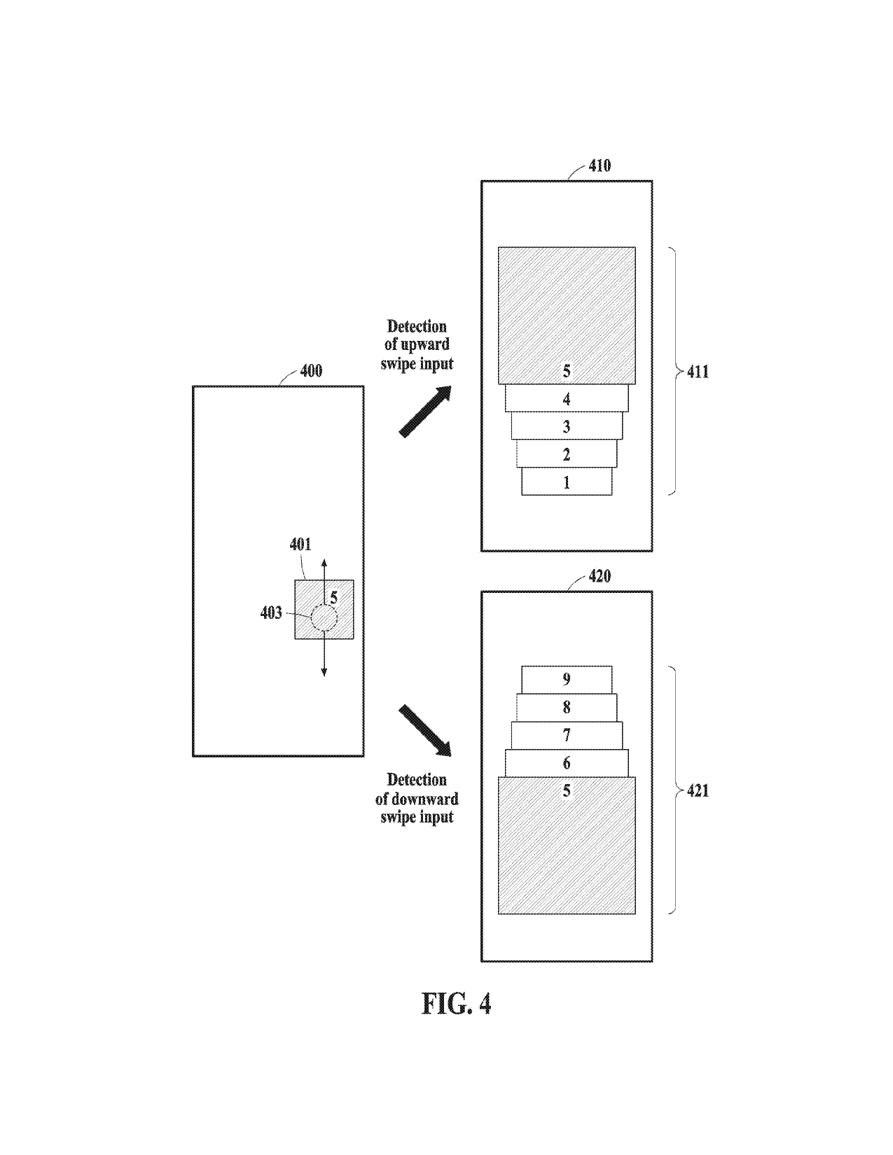

FIG. 4 is a diagram illustrating an arrangement of items according to an embodiment of the disclosure.

Referring to FIG. 4, a home screen 400 (e.g., the home screen 200 of FIG. 2, the home screen 230 of FIG. 2, or the home screen 300 of FIG. 2) displaying a widget icon 401 (e.g., the widget icon 201 of FIG. 2 or the widget icon 301 of FIG. 3) is illustrated. The electronic device (e.g., the electronic device of FIG. 1) may detect an upward swipe input or a downward swipe input based on the widget icon 401 after a touch 403 (e.g., the touch 203 of FIG. 2 or the touch 303 of FIG. 3) on the widget icon 401.

In response to detecting an upward swipe input on the home screen 400, the electronic device may display a control screen 410 (e.g., the control screen 210 of FIG. 2, the control screen 220 of FIG. 2, or the control screen 320 of FIG. 3) through a visual effect that slides one or more candidate items downward relative to a target item (i.e., item 5). The control screen 410 may include an item list 411 (e.g., the item list 211 of FIG. 2 or the item list 321 of FIG. 3) in which items are arranged in descending order. The descending order may include various types of descending order, such as descending order of item generation dates, descending order of item names, and descending order of item capacities. Item 5 may be arranged at the top of the item list 411, and items 4 through 1 may be sequentially arranged below item 5. For example, when the widget icon 401 is a music widget, the item list 411 may arrange an album cover of a currently playing song at the top and may sequentially arrange album covers of songs that have already been played below the album cover in descending order (i.e., in order of most recently played).

In response to detecting a downward swipe input on the home screen 400, the electronic device may display a control screen 420 (e.g., the control screen 210 of FIG. 2, the control screen 220 of FIG. 2, or the control screen 320 of FIG. 3) through a visual effect that slides one or more candidate items upward relative to a target item (i.e., item 5). The control screen 420 may include the item list 421 (e.g., the item list 211 of FIG. 2 or the item list 321 of FIG. 3) in which items are arranged in ascending order. The ascending order may include various types of ascending order, such as ascending order of item generation dates, ascending order of item names, and ascending order of item capacities. Item 5 may be arranged at the top of the item list 421, and items 6 through 9 may be sequentially arranged below item 5. For example, when the widget icon 401 is a music widget, the item list 421 may arrange an album cover of a currently playing song at the top and may sequentially arrange album covers of songs to be played next below the album cover in ascending order (i.e., in an order in which the songs are to be played after the currently playing song).

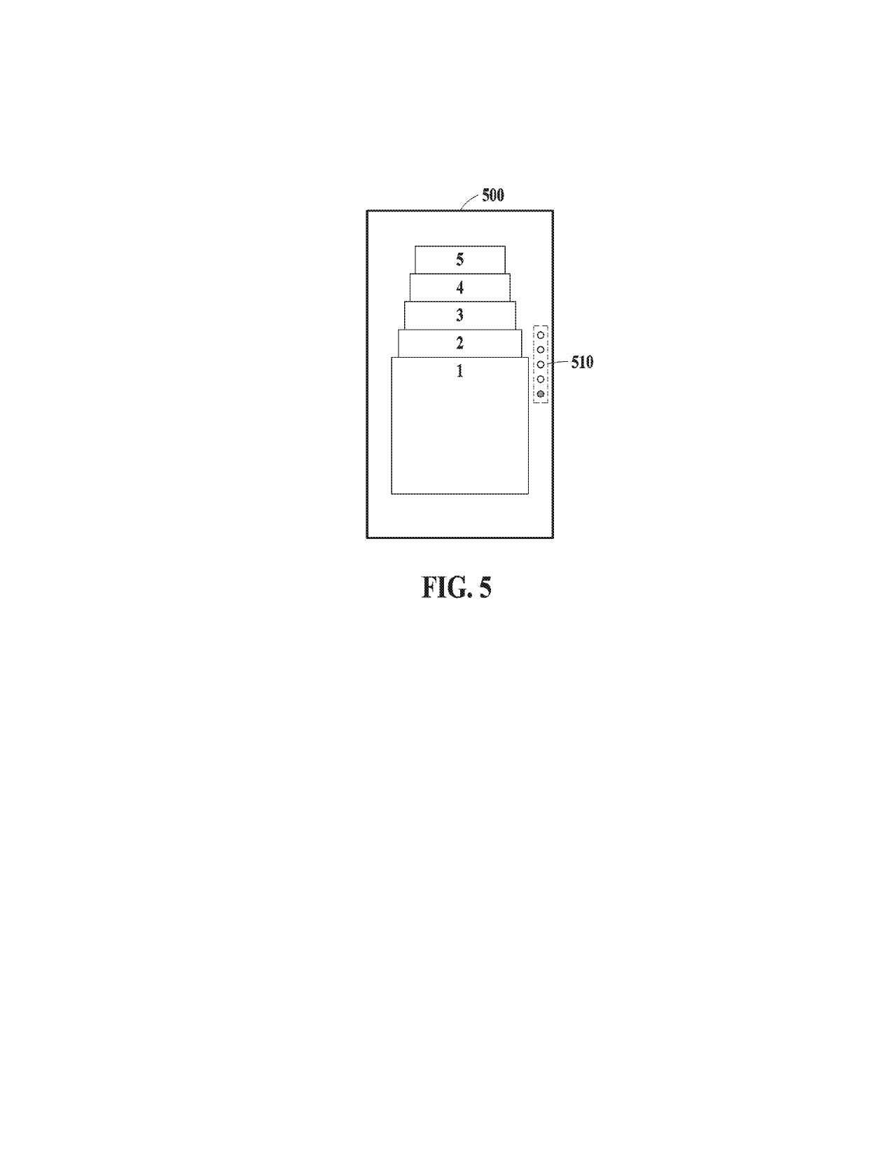

FIG. 5 is a diagram illustrating a display of an indicator according to an embodiment of the disclosure.

Referring to FIG. 5, a control screen 500 (e.g., the control screen 210 of FIG. 2, the control screen 220 of FIG. 2, the control screen 320 of FIG. 3, the control screen 410 of FIG. 4, or the control screen 420 of FIG. 4) that is being displayed by an electronic device (e.g., the electronic device 101 of FIG. 1) is illustrated. The electronic device may further display an indicator 510 indicating positions of items on the control screen 500. The indicator 510 may be of various types, such as a dot type or a scroll bar type.

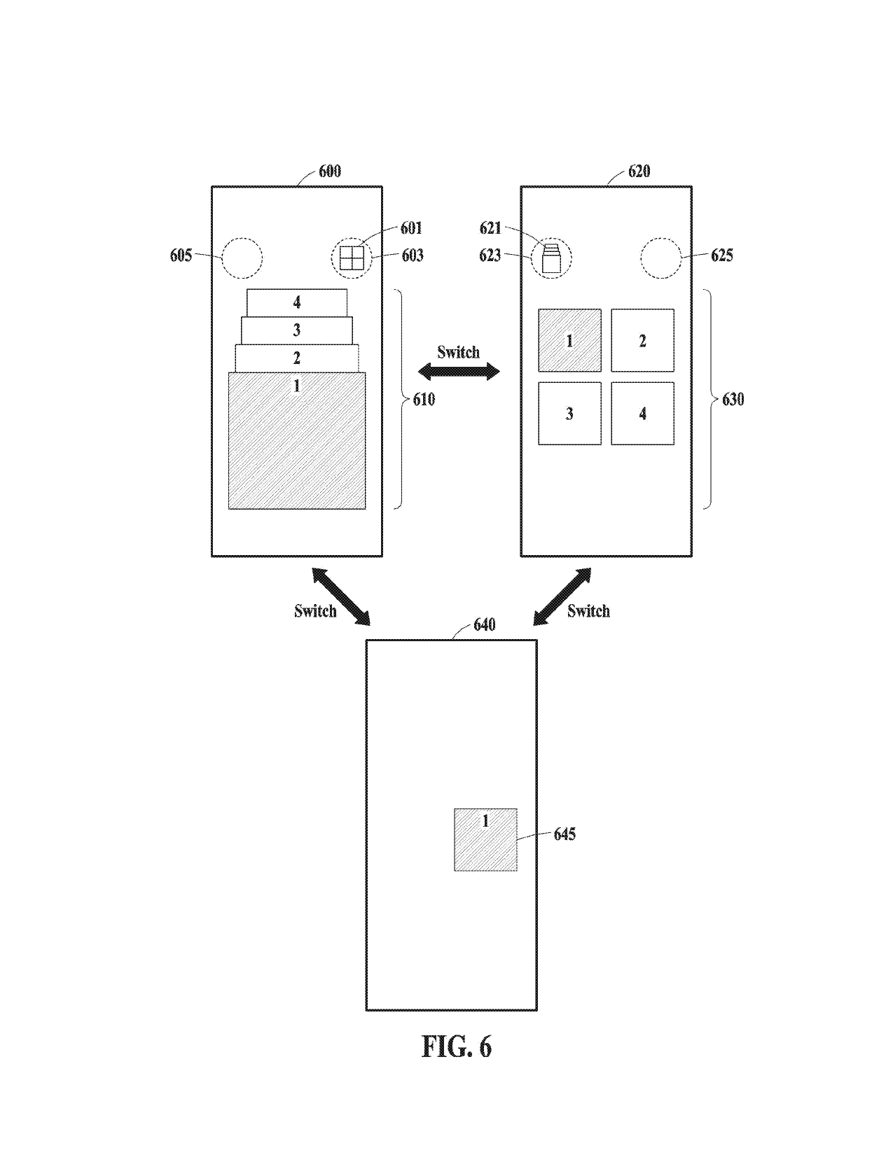

FIG. 6 is a diagram illustrating a method of displaying items according to an embodiment of the disclosure.

The electronic device (e.g., the electronic device 101 of FIG. 1) may provide a control screen in various manners. The electronic device may provide an item list 610 (e.g., the item list 211 of FIG. 2, the item list 321 of FIG. 3, the item list 411 of FIG. 4, or the item list 421 of FIG. 4) in a stack view on a control screen 600 (e.g., the control screen 210 of FIG. 2, the control screen 220 of FIG. 2, the control screen 320 of FIG. 3, the control screen 410 of FIG. 4, the control screen 420 of FIG. 4, or the control screen 500 of FIG. 5). The electronic device may provide an item list 630 in a grid view on the control screen 620.

The electronic device may switch between the control screen 620 and the control screen 600 and display the switched screen on a display module (e.g., the display module 160 of FIG. 1).

The electronic device may switch the displayed screen from the control screen 600 to the control screen 620 in response to detecting a touch 603 on an indicator 601 indicating a grid view. The electronic device may switch the displayed screen from the control screen 620 to the control screen 600 in response to detecting a touch 623 on an indicator 621 indicating a stack view.

In response to detecting a touch 605 (e.g., the touch 219 of FIG. 2 or the touch 221 of FIG. 2) on a background of the control screen 600, the electronic device may switch the displayed screen from the control screen 600 to a home screen 640 (e.g., the home screen 200 of FIG. 2, the home screen 230 of FIG. 2, the home screen 300 of FIG. 3, or the home screen 400 of FIG. 4). The home screen 640 may include a widget icon 645 (e.g., the widget icon 201 of FIG. 2, the widget icon 301 of FIG. 3, or the widget icon 401 of FIG. 4). The widget icon 645 may display a target item (e.g., the target item 205 of FIG. 2 or the target item 305). In this case, the target item may be item 1 at the top of the item list 610. The electronic device may store a view type of a control screen before displaying the home screen 640. Accordingly, in response to detecting a first touch input while displaying the home screen 640, the electronic device may switch the displayed screen from the home screen 640 to the control screen 600.

In response to detecting a touch 625 on a background of the control screen 620, the electronic device may switch the displayed screen from the control screen 620 to the home screen 640. The home screen 640 may include the widget icon 645. The widget icon 645 may display the target item. In this case, the target item may be item 1 selected from the item list 630. The electronic device may store a view type of a control screen before displaying the home screen 640. Accordingly, in response to detecting a first touch input while displaying the home screen 640, the electronic device may switch the displayed screen from the home screen 640 to the control screen 620.

FIGS. 7 and 8 are diagrams illustrating control over a widget based on a second touch input according to various embodiments of the disclosure.

Referring to FIG. 7, a control screen 700 (e.g., the control screen 210 of FIG. 2, the control screen 220 of FIG. 2, the control screen 320 of FIG. 3, the control screen 410 of FIG. 4, the control screen 420 of FIG. 4, the control screen 500 of FIG. 5, or the control screen 600 of FIG. 6) that is being displayed by an electronic device (e.g., the electronic device 101 of FIG. 1) is illustrated. For ease of description, FIG. 7 will be described based on a stack view in which items 2 through 5 are arranged in an upward direction relative to item 1. However, it will be apparent to those skilled in the art that the following description may also apply to a stack view in which items 2 through 5 are arranged in a downward direction relative to item 1.

The electronic device may detect a touch 710 (e.g., the touch 215 of FIG. 2) on an item (i.e., a target item (e.g., the target item 205 of FIG. 2 or the target item 305 of FIG. 3)) arranged at the top of an item list 730 (e.g., the item list 211 of FIG. 2, the item list 321 of FIG. 3, the item list 411 of FIG. 4, the item list 421 of FIG. 4, or the item list 610 of FIG. 6). The electronic device may detect an upward swipe input 711 or a downward swipe input 713 after the touch 710. In other words, the electronic device may detect a second touch input.

In response to detecting the upward swipe input 711 after the touch 710, the electronic device may slide the items included in the item list 730 upward. The electronic device may slide the items in the item list 730 upward such that an item preceding item 1 is displayed at the top of the item list 730.

The electronic device may display items preceding item 1 based on an extent of the upward swipe input 711. In other words, the electronic device may cause items preceding item 1 to be displayed based on the speed and/or the length of the upward swipe input 711. For example, as the speed of the upward swipe input 711 increases, the electronic device may slide the items in the item list 730 upward more promptly such that a greater number of items preceding item 1 are displayed. For example, as the length of the upward swipe input 711 increases, the electronic device may slide the items in the item list 730 upward more promptly such that a greater number of items preceding item 1 are displayed.

In response to detecting the upward swipe input 711 after the touch 710, items preceding item 1 in the item list 730 may not exist. In this case, the electronic device may add a new item 740. For example, when it is associated with a note widget, and item 1 is a most recently written note item, the electronic device may add a new note item and provide an opportunity to write the new note item.

In response to detecting the downward swipe input 713 after the touch 710, the electronic device may slide the items in the item list 730 downward. The electronic device may slide the items in the item list 730 downward such that items (e.g., items 2 through 5) following item 1 are displayed at the top of the item list 730. The electronic device may display items 2 through 5 at the top of the item list 730 and display another item 750 at the bottom of the item list 730. The other item 750 may vary depending on the arrangement criterion of the item list 730. For example, in a memo widget, the other item 750 may be a memo item generated earlier than item 5. For example, in a music widget, the other item 750 may be an album cover of a song to be played after item 5.

The electronic device may display items following item 1 based on an extent of the downward swipe input 713. In other words, the electronic device may cause items following item 1 to be displayed based on the speed and/or the length of the downward swipe input 713. The description of displaying an item according to a swiped extent has been provided above, and thus a repeated description thereof will be omitted.

According to an embodiment, the electronic device may detect a touch 720 on items arranged below the top item in the item list 730, rather than detecting the touch 710 on the top item. The electronic device may detect the downward swipe input 713 or the upward swipe input 711 after the touch 720. In other words, the electronic device may detect a second touch input with respect to items arranged below the top item. In this case, the operation of the electronic device in response to the second touch input with respect to the above-described top item may also apply, and thus a repeated description thereof will be omitted.

Referring to FIG. 8, a control screen 800 (e.g., the control screen 210 of FIG. 2, the control screen 220 of FIG. 2, the control screen 320 of FIG. 3, the control screen 410 of FIG. 4, the control screen 420 of FIG. 4, the control screen 500 of FIG. 5, the control screen 600 of FIG. 6, or the control screen 700 of FIG. 7) that is being displayed by an electronic device (e.g., the electronic device 101 of FIG. 1) is illustrated. For ease of description, FIG. 8 will be described based on a stack view in which items 2 through 5 are arranged in an upward direction relative to item 1. However, it will be apparent to those skilled in the art that the following description may also apply to a stack view in which items 2 through 5 are arranged in a downward direction relative to item 1.

The electronic device may detect a touch 810 (e.g., the touch 215 of FIG. 2 or the touch 710 of FIG. 7) on an item (i.e., a target item (e.g., the target item 205 of FIG. 2 or the target item 305 of FIG. 3)) arranged at the top of an item list 830 (e.g., the item list 211 of FIG. 2, the item list 321 of FIG. 3, the item list 411 of FIG. 4, the item list 421 of FIG. 4, the item list 610 of FIG. 6, or the item list 730 of FIG. 7). The electronic device may detect a left swipe input 811 or a right swipe input 813 after the touch 810. In other words, the electronic device may detect a second touch input.

In response to detecting the left swipe input 811 or the right swipe input 813 after the touch 810, the electronic device may slide item 1 to the left or right to remove item 1 from the control screen 800. The electronic device may further perform a predetermined operation together with sliding item 1 to the left or right to remove item 1 from the control screen 800. In other words, the electronic device may further perform, together with sliding item 1 to the left to remove item 1 from the control screen 800, a predetermined operation mapped to the sliding operation. In other words, the electronic device may further perform, together with sliding item 1 to the right to remove item 1 from the control screen 800, a predetermined operation mapped to the sliding operation. The predetermined operation may include operations such as deleting an item or setting a pin to provide a separate interaction.

For example, the predetermined operation may be deleting an item. The electronic device may detect the left swipe input 811 after the touch 810. The electronic device may delete item 1 by sliding item 1 to the left to remove item 1 from the control screen 800. For example, when the widget is a memo widget, the electronic device may delete a memo item by sliding the memo item to the left to remove the memo item from the control screen 800.

For example, the predetermined operation may include setting a pin to provide a separate interaction. The additional interaction may include generating a favorites list or a shared list. The electronic device may detect the right swipe input 813 after the touch 810. The electronic device may move item 1 to a separate list by sliding item 1 to the right to remove item 1 from the control screen 800.

In addition, the electronic device may detect a touch 820 (e.g., the touch 720 of FIG. 7) on items (e.g., items 2 through 5) arranged below the top item. For ease of description, it is assumed that the touch 820 is a contact with item 3.

The electronic device may detect the left swipe input 811 or the right swipe input 813 after the touch 820. In response to detecting the left swipe input 811 or the right swipe input 813, the electronic device may slide item 3 to the left or right to remove item 3 from the control screen 800. Operation of the electronic device in response to detecting a second touch input with respect to items arranged below the top item may be the same as operation of the electronic device in response to detecting a second touch input with respect to the top item, and thus a repeated description thereof will be omitted.

According to an embodiment, the control screen 800 may include a cue area 850 and a cue area 840. The electronic device may display a cue associated with a predetermined operation to be performed in response to the left swipe input 811 with respect to an item in the cue area 850. For example, when the predetermined operation performed in response to the left swipe input 811 is deleting an item, the electronic device may display a trash can image as a cue in the cue area 850. The electronic device may display a cue indicating a predetermined operation to be performed in response to the right swipe input 813 with respect to an item in the cue area 840. For example, when the predetermined operation performed in response to the right swipe input 813 is generating a favorites list, the electronic device may display an image representing the favorites list as a cue in a cue area 850.

Hereinafter, moving an item to a list for providing a separate interaction will be described.

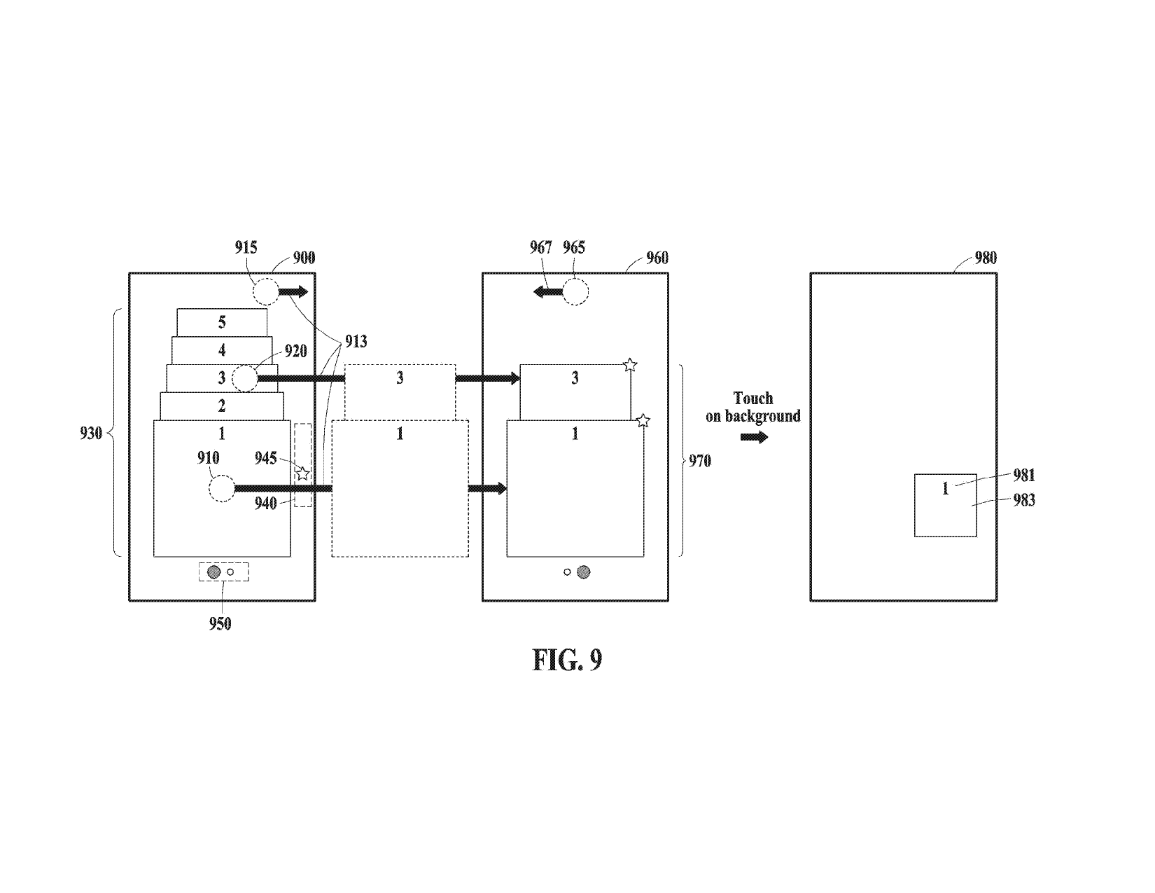

FIG. 9 is a diagram illustrating a separate interaction according to an embodiment of the disclosure.

Referring to FIG. 9, a control screen 900 (e.g., the control screen 210 of FIG. 2, the control screen 220 of FIG. 2, the control screen 320 of FIG. 3, the control screen 410 of FIG. 4, the control screen 420 of FIG. 4, the control screen 500 of FIG. 5, the control screen 600 of FIG. 6, the control screen 700 of FIG. 7, or the control screen 800 of FIG. 8) that is being displayed by an electronic device (e.g., the electronic device 101 of FIG. 1) is illustrated. For ease of description, FIG. 9 will be described based on a stack view in which items 2 through 5 are arranged in an upward direction relative to item 1. However, it will be apparent to those skilled in the art that the following description may also apply to a stack view in which items 2 through 5 are arranged in a downward direction relative to item 1.

The electronic device may detect a touch 910 (e.g., the touch 215 of FIG. 2, the touch 710 of FIG. 7, or the touch 810 of FIG. 8) on an item (i.e., a target item (e.g., the target item 205 of FIG. 2 or the target item 305 of FIG. 3)) arranged at the top of an item list 930 (e.g., the item list 211 of FIG. 2, the item list 321 of FIG. 3, the item list 411 of FIG. 4, the item list 421 of FIG. 4, the item list 610 of FIG. 6, the item list 730 of FIG. 7, or the item list 830 of FIG. 8). The electronic device may detect a left swipe input (e.g., the left swipe input 811 of FIG. 8) or a right swipe input 913 (e.g., the right swipe input 813 of FIG. 8) after the touch 910.

Hereinafter, for ease of description, it is assumed that the right swipe input 913 has been detected. In addition, it is assumed that a predetermined operation mapped to the right swipe input 913 is a pin setting for generating a favorite. However, the disclosure is not limited thereto.

A screen 900 may include a cue area 940 (e.g., the cue area 840 of FIG. 8 or the cue area 850 of FIG. 8). Referring to FIG. 9, the cue area 940 may include a cue 945 indicating generation of a favorites list in response to the touch 910 and the right swipe input 913.

In response to detecting the touch 910 and the right swipe input 913 on the top item (i.e., item 1), the electronic device may apply a visual effect that slides the top item to the right and may switch the screen from the control screen 900 to a separate list display screen 960. Likewise, in response to detecting a touch 920 (e.g., the touch 720 of FIG. 7 or the touch 820 of FIG. 8) on items (i.e., items 2 through 4) below the top item and the right swipe input 913, the electronic device may apply a visual effect that slides the touched item to the right and may switch the screen from the control screen 900 to the separate list display screen 960.

The electronic device may detect a touch 915 on a background rather than on the item list 930. In response to detecting the touch 915, the electronic device may switch the screen from the control screen 900 to the separate list display screen 960 without applying a visual effect that slides an item to the right.

The control screen 900 and the separate list display screen 960 may further include an indicator 950 indicating the currently displayed screen. The indicator may be various types, such as a dot type or a slide type.

The separate list display screen 960 may include an item list 970 for a separate interaction different from the item list 930. For example, the item list 970 may be a list of items pinned for generation of a favorites list. Items included in the item list 970 may include an indicator indicating that the items are pinned. For example, items included in the item list 970 may include the cue 945 as the indicator.

Although not illustrated in FIG. 9, the electronic device may unpin items included in the item list 970. The electronic device may detect a touch and a swipe input in a direction opposite to the pin setting with respect to items included in the item list 970. The electronic device may detect a touch and a left swipe input (e.g., the left swipe input 811 of FIG. 8) with respect to items included in the item list 970. The electronic device may apply a visual effect that slides the touched item to the left and switch the screen from the separate list display screen 960 to the control screen 900. The electronic device may unpin the item by applying a visual effect that slides the touched item to the left.

The electronic device may detect a touch 965 on the separate list display screen 960. In response to detecting the touch 965, the electronic device may switch the screen from the separate list display screen 960 to the home screen 980 (e.g., the home screen 200 of FIG. 2, the home screen 230 of FIG. 2, the home screen 300 of FIG. 3, the home screen 400 of FIG. 4, or the home screen 640 of FIG. 6). When the screen switches from the separate list display screen 960 to the home screen 980, an item (i.e., item 1) arranged on the top of the item list 970 may be displayed as a target item 983 (e.g., the target item 205 of FIG. 2 or the target item 305) of a widget icon 981 (e.g., the widget icon 201 of FIG. 2, the widget icon 301 of FIG. 3, the widget icon 401 of FIG. 4, or the widget icon 645 of FIG. 6).

The electronic device may detect the touch 965 and a left swipe input 967 on the separate list display screen 960. In response to detecting the touch 965 and the left swipe input 967, the electronic device may switch the screen from the separate list display screen 960 to the control screen 900.

According to an embodiment, when the screen switches from the separate list display screen 960 to the control screen 900, the item list 930 of the control screen 900 may not display items included in the item list 970. For example, the item list 930 may include items 2 and 4 through 7 without including items 1 and 3 included in the item list 970.

According to an embodiment, when the screen switches from the separate list display screen 960 to the control screen 900, the item list 930 may display items included in the item list 970, and an indicator (i.e., the cue 945) may be displayed for the items. For example, the item list 930 may display items 1 through 5, and an indicator (i.e., the cue 945) may be displayed for items 1 and 3.

When the screen switches to the home screen 980, the electronic device may store which screen was displayed before switching to the home screen 980. Accordingly, when the screen switches from the separate list display screen 960 to the home screen 980, in response to detecting a first touch input to the widget icon 981, the electronic device may enter the separate list display screen 960. In addition, when the screen switches from the control screen 900 to the home screen 980, in response to detecting a first touch input to the widget icon 981, the electronic device may enter the control screen 900.

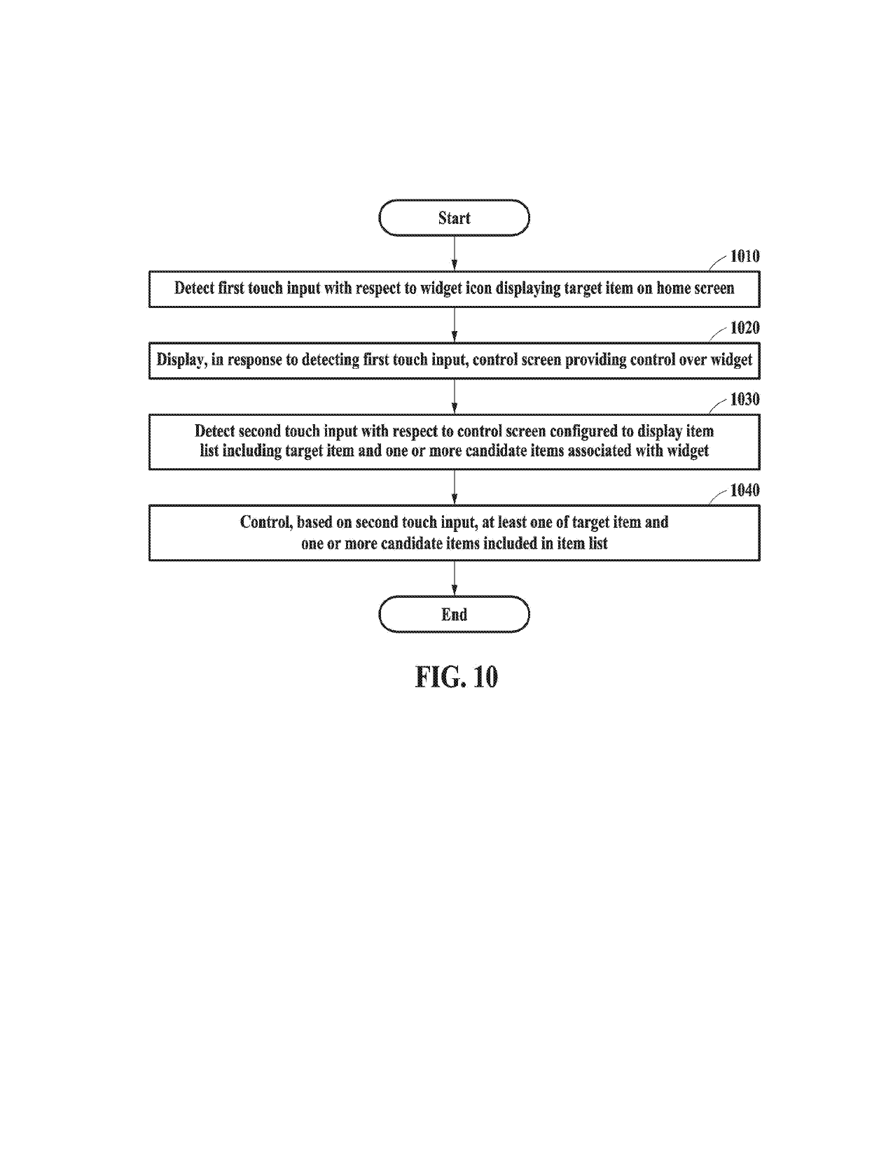

FIG. 10 is a diagram illustrating a method of operating an electronic device according to an embodiment of the disclosure.

In the following embodiments, operations may be performed sequentially but not necessarily. For example, the order of the operations may be changed and at least two of the operations may be performed in parallel. Operations 1010 to 1040 may be performed by at least one component (e.g., the processor 120 of FIG. 1) of the electronic device (e.g., the electronic device 101 of FIG. 1).

In operation 1010, the electronic device may detect a first touch input with respect to a widget icon (e.g., the widget icon 201 of FIG. 2, the widget icon 301 of FIG. 3, the widget icon 401 of FIG. 4, the widget icon 645 of FIG. 6, or the widget icon 981 of FIG. 9) displaying a target item (e.g., the target item 205 of FIG. 2, the target item 305 of FIG. 3, or the target item 983 of FIG. 9) on a home screen (e.g., the home screen 200 of FIG. 2, the home screen 230 of FIG. 2, the home screen 300 of FIG. 3, the home screen 400 of FIG. 4, the home screen 640 of FIG. 6, or the home screen 980 of FIG. 9).

In operation 1020, the electronic device may display, in response to detecting the first touch input, a control screen (e.g., the control screen 210 of FIG. 2, the control screen 220 of FIG. 2, the control screen 320 of FIG. 3, the control screen 410 of FIG. 4, the control screen 420 of FIG. 4, the control screen 500 of FIG. 5, the control screen 600 of FIG. 6, the control screen 700 of FIG. 7, the control screen 800 of FIG. 8, or the control screen 900 of FIG. 9) providing control over a widget.

In operation 1030, the electronic device may detect a second touch input with respect to the control screen configured to display an item list (e.g., the item list 211 of FIG. 2, the item list 321 of FIG. 3, the item list 411 of FIG. 4, the item list 421 of FIG. 4, the item list 610 of FIG. 6, the item list 730 of FIG. 7, the item list 830 of FIG. 8, or the item list 930 of FIG. 9) including the target item and one or more candidate items (e.g., the one or more candidate items 213 of FIG. 2) associated with the widget.

In operation 1040, the electronic device may control, based on the second touch input, at least one of the target item and the one or more candidate items included in the item list.

The operations illustrated in FIG. 10 may be performed based on the descriptions provided with reference to FIGS. 1 to 9, and thus a repeated description thereof will be omitted.

According to an embodiment, the displaying of the control screen may include arranging the target item at a top position and displaying, on the control screen, the item list arranged such that each of the one or more candidate items below the target item at least partially overlaps with a consecutive item.

According to an embodiment, the first touch input may include an upward swipe input (e.g., the upward swipe input 711 of FIG. 7) or a downward swipe input (e.g., the downward swipe input 713 of FIG. 7) with respect to the widget icon after a touch (e.g., the touch 203 of FIG. 2, the touch 303 of FIG. 3, or the touch 403 of FIG. 4) on the widget icon.

According to an embodiment, the displaying of the control screen may include arranging, based on the first touch input, the target item and the one or more candidate items in ascending order or descending order in the item list.

According to an embodiment, the displaying of the control screen may include displaying the item list on the control screen through a visual effect that expands the size of the target item, and a visual effect that slides the one or more candidate items upward or downward relative to the target item.

According to one embodiment, the controlling of at least one of the target item and the one or more candidate items included in the item list may include deleting an item included in the item list when the second touch input includes a swipe input in a first direction after a touch (e.g., the touch 710 of FIG. 7, the touch 720 of FIG. 7, the touch 810 of FIG. 9, the touch 820 of FIG. 8, the touch 910 of FIG. 9, or the touch 920 of FIG. 9) on at least a portion of the control screen.

According to an embodiment, the controlling of at least one of the target item and the one or more candidate items included in the item list may include moving an item included in the item list to a list (e.g., the item list 970 of FIG. 9) configured to provide a separate interaction when the second touch input includes a swipe input in a second direction after a touch on at least a portion of the control screen.

According to an embodiment, the controlling of at least one of the target item and the one or more candidate items included in the item list may include sliding the item list in a third direction or a fourth direction based on an extent of the swipe input when the second touch input includes a swipe input in the third direction or the fourth direction after a touch on at least a portion of the control screen.

According to an embodiment, an operating method may include detecting a first touch input with respect to a widget icon displaying a target item on a home screen. The operating method may include displaying, in response to detecting the first touch input, a control screen providing control over a widget through a visual effect that expands the size of the target item. The operating method may include detecting a second touch input with respect to the control screen displaying an item list including the target item and one or more candidate items associated with the widget. The operating method may include controlling, based on the second touch input, at least one of the target item and the one or more candidate items included in the item list. The item list may be arranged such that each of the one or more candidate items, below the target item at a top position, may at least partially overlap with a consecutive item.

According to an embodiment, an electronic device may include memory storing instructions. The electronic device may include a processor configured to execute the instructions. The instructions, when executed by the processor, may cause the electronic device to detect a first touch input with respect to a widget icon displaying a target item on a home screen. The instructions, when executed by the processor, may cause the electronic device to display, in response to detecting the first touch input, a control screen providing control over a widget. The instructions, when executed by the processor, may cause the electronic device to detect a second touch input with respect to the control screen configured to display an item list including the target item and one or more candidate items associated with the widget. The instructions, when executed by the processor, may cause the electronic device to control, based on the second touch input, at least one of the target item and the one or more candidate items included in the item list. The target item and the one or more candidate items may provide at least a portion of functions of an application associated with the widget. The one or more candidate items may replace the target item and may be displayed on the home screen as the widget icon.

According to an embodiment, the instructions, when executed by the processor, may cause the electronic device to arrange the target item at a top position and display, on the control screen, the item list arranged such that each of the one or more candidate items below the target item at least partially overlaps with a consecutive item.

According to an embodiment, the first touch input may include an upward swipe input or a downward swipe input with respect to the widget icon after a touch on the widget icon.

According to an embodiment, the instructions, when executed by the processor, may cause the electronic device to arrange, based on the first touch input, the target item and the one or more candidate items in ascending order or descending order in the item list.

According to an embodiment, the instructions, when executed by the processor, may cause the electronic device to display the item list on the control screen through a visual effect that expands the size of the target item, and a visual effect that slides the one or more candidate items upward or downward relative to the target item.

According to an embodiment, the instructions, when executed by the processor, may cause the electronic device to delete an item included in the item list when the second touch input includes a swipe input in a first direction after a touch on at least a portion of the control screen.

According to an embodiment, the instructions, when executed by the processor, may cause the electronic device to move an item included in the item list to a list configured to provide a separate interaction when the second touch input includes a swipe input in a second direction after a touch on at least a portion of the control screen.

According to an embodiment, the instructions, when executed by the processor, may cause the electronic device to slide items included in the item list in a third direction or a fourth direction based on an extent of the swipe input when the second touch input includes a swipe input in the third direction or the fourth direction after a touch on at least a portion of the control screen.

According to an embodiment, the instructions, when executed by the processor, may cause the electronic device to add a new item (e.g., the new item 740 of FIG. 7) before a first item when an item arranged at the top of the control screen is the first item of the item list, and the second touch input includes a swipe input in the third direction or the fourth direction after a touch on at least a portion of the control screen.

According to an embodiment, the instructions, when executed by the processor, may cause the electronic device to display another item (e.g., the other item 750 of FIG. 7) at the bottom of the item list when the second touch input includes a swipe input in the third direction or the fourth direction after a touch on at least a portion of the control screen.

According to an embodiment, an electronic device may include memory storing instructions. The electronic device may include a processor configured to execute the instructions. The instructions, when executed by the processor, may cause the electronic device to detect a first touch input with respect to a widget icon displaying a target item on a home screen. The instructions, when executed by the processor, may cause the electronic device to display, in response to detecting the first touch input, a control screen providing control over a widget through a visual effect that expands the size of the target item. The instructions, when executed by the processor, may cause the electronic device to detect a second touch input with respect to the control screen configured to display an item list including the target item and one or more candidate items associated with the widget. The instructions, when executed by the processor, may cause the electronic device to control, based on the second touch input, at least one of the target item and the one or more candidate items included in the item list. The item list may be arranged such that each of the one or more candidate items, below the target item at a top position, may at least partially overlap with a consecutive item.

The embodiments of the disclosure disclosed in the specification and the drawings are merely presented to easily describe technical contents of the embodiments of the disclosure and help the understanding of them and are not intended to limit the embodiments. Therefore, all changes or modifications derived from the technical idea of the embodiments of the disclosure as well as the embodiments disclosed herein should be construed to fall within the embodiments.

According to an embodiment, a non-transitory computer-readable storage medium may store instructions that, when executed by a processor, cause the processor to perform the method.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions; and
one or more processors communicatively coupled to the memory,
wherein the instructions, when executed by the one or more processors individually or collectively, cause the electronic device to:
detect a first touch input with respect to a widget icon displaying a target item on a home screen,
display, in response to detecting the first touch input, a control screen providing control over a widget,
detect a second touch input with respect to the control screen displaying an item list, the item list including the target item and one or more candidate items associated with the widget, and
control, based on the second touch input, at least one of the target item or the one or more candidate items of the item list,
wherein the target item and the one or more candidate items each provide at least a portion of functions of an application associated with the widget, and
wherein the one or more candidate items are items that (i) replace the target item and (ii) are displayed on the home screen as the widget icon.

2. The electronic device of claim 1,
wherein the instructions, when executed by the one or more processors individually or collectively, further cause the electronic device to display the item list on the control screen, and
wherein the item list includes (i) the target item arranged at a top position and (ii) the one or more candidate items arranged below the target item such that each of the one or more candidate items at least partially overlaps with a consecutive item.

3. The electronic device of claim 1, wherein the first touch input includes:
an upward swipe input or a downward swipe input with respect to the widget icon after a touch on the widget icon.

4. The electronic device of claim 1, wherein the instructions, when executed by the one or more processors individually or collectively, further cause the electronic device to arrange, based on the first touch input, the target item and the one or more candidate items in ascending order or descending order in the item list.

5. The electronic device of claim 1, wherein the instructions, when executed by the one or more processors individually or collectively, further cause the electronic device to display the item list on the control screen through (i) a visual effect that expands a size of the target item, and (ii) a visual effect that slides the one or more candidate items upward or downward relative to the target item.

6. The electronic device of claim 1, wherein the instructions, when executed by the one or more processors individually or collectively, further cause the electronic device to delete an item included in the item list when the second touch input includes a swipe input in a first direction after a touch on at least a portion of the control screen.

7. The electronic device of claim 1, wherein the instructions, when executed by the one or more processors individually or collectively, further cause the electronic device to move an item included in the item list to a list for providing a separate interaction when the second touch input includes a swipe input in a second direction after a touch on at least a portion of the control screen.

8. The electronic device of claim 1, wherein the instructions, when executed by the one or more processors individually or collectively, further cause the electronic device to slide items included in the item list in a third direction or a fourth direction based on an extent of a swipe input when the second touch input respectively includes the swipe input in the third direction or the fourth direction after a touch on at least a portion of the control screen.

9. The electronic device of claim 8, wherein the instructions, when executed by the one or more processors individually or collectively, further cause the electronic device to add a new item before a first item when (i) an item arranged at a top of the control screen is the first item of the item list, and (ii) the second touch input includes a swipe input in the third direction or the fourth direction after a touch on the at least a portion of the control screen.

10. The electronic device of claim 8, wherein the instructions, when executed by the one or more processors individually or collectively, further cause the electronic device to display an additional item at a bottom of the item list when the second touch input includes a swipe input in the third direction or the fourth direction after a touch on the at least a portion of the control screen.

11. An electronic device comprising:
memory, comprising one or more storage media, storing instructions; and
one or more processors communicatively coupled to the memory,
wherein the instructions, when executed by the one or more processors individually or collectively, cause the electronic device to:
detect a first touch input with respect to a widget icon displaying a target item on a home screen,
display, in response to detecting the first touch input, a control screen providing control over a widget through a visual effect that expands a size of the target item,
detect a second touch input with respect to the control screen displaying an item list, the item list including the target item and one or more candidate items associated with the widget, and
control, based on the second touch input, at least one of the target item or the one or more candidate items of the item list, and
wherein the item list is arranged such that each of the one or more candidate items, below the target item at a top position, at least partially overlaps with a consecutive item.

12. A method of operating an electronic device, the method comprising:
detecting a first touch input with respect to a widget icon displaying a target item on a home screen;
displaying, in response to the detecting of the first touch input, a control screen providing control over a widget;
detecting a second touch input with respect to the control screen displaying an item list, the item list including the target item and one or more candidate items associated with the widget; and
controlling, based on the second touch input, at least one of the target item or the one or more candidate items of the item list,
wherein the target item and the one or more candidate items each provide at least a portion of functions of an application associated with the widget, and
wherein the one or more candidate items are items that (i) replace the target item and (ii) are displayed on the home screen as the widget icon.

13. The method of claim 12, wherein the displaying of the control screen includes:
displaying the item list on the control screen, and
wherein the item list is includes (i) the target item arranged at a top position and (ii) the one or more candidate items arranged below the target item such that each of the one or more candidate items at least partially overlaps with a consecutive item.

14. The method of claim 12, wherein the first touch input includes:
an upward swipe input or a downward swipe input with respect to the widget icon after a touch on the widget icon.

15. The method of claim 12, wherein the displaying of the control screen includes:
arranging, based on the first touch input, the target item and the one or more candidate items in ascending order or descending order in the item list.

16. The method of claim 12, wherein the displaying of the control screen includes:
displaying the item list on the control screen through (i) a visual effect that expands a size of the target item, and (ii) a visual effect that slides the one or more candidate items upward or downward relative to the target item.

17. The method of claim 12, wherein the controlling of the at least one of the target item or the one or more candidate items of the item list includes:
deleting an item included in the item list when the second touch input includes a swipe input in a first direction after a touch on at least a portion of the control screen.

18. The method of claim 12, wherein the controlling of the at least one of the target item or the one or more candidate items of the item list includes:
moving an item included in the item list to a list for providing a separate interaction when the second touch input includes a swipe input in a second direction after a touch on at least a portion of the control screen.

19. The method of claim 12, wherein the controlling of the at least one of the target item or the one or more candidate items of the item list includes:
sliding items included in the item list in a third direction or a fourth direction based on an extent of a swipe input when the second touch input respectively includes the swipe input in the third direction or the fourth direction after a touch on at least a portion of the control screen.

20. One or more non-transitory computer-readable storage media storing one or more computer programs including computer-executable instructions that, when executed by one or more processors of an electronic device individually or collectively, cause the electronic device to perform operations, the method of claim 12.
